(19) United States
(12) Patent Application Publication
(10) Pub. No.: US 2005/0048251 A1
(43) Pub. Date: Mar. 3, 2005

(54) Silver alloys for optical data storage and optical media containing same

(75) Inventor: Heiner Lichtenberger, Williamsville, NY (US)

Correspondence Address: HISCOCK & BARCLAY, LLP, 2000 HSBC PLAZA, ROCHESTER, NY, 14604-2404, US

(73) Assignee: Williams Advanced Materials, Inc.

(21) Appl. No.: 10/930,178

(22) Filed: Aug. 31, 2004

Related U.S. Application Data
(60) Provisional application No. 60/499,842, filed on Sep. 3, 2003.

(51) Int. Cl. B32B 3/02

(52) U.S. Cl. 428/64.4

(57) ABSTRACT

An optical data recording and storage medium includes a thin semi-reflective layer and a highly reflective layer, wherein the semi-reflective layer is formed from a silver alloy containing pure silver and not more than about 0.1 to about 1.0 wt. % of tin, based on the total weight of alloy, with the tin deposited substantially entirely at the grain boundaries of the silver in the semi-reflective layer. The silver alloy may also include along with the tin about 0.1 to about 1.0 wt each of copper, based on the total weight of alloy, without defeating the benefit of the tin.

### A. REFERENCE TO PRIOR CO-PENDING APPLICATIONS

This application claims the benefit of co-pending U.S. Provisional Patent Application No. 60/499,842, filed Sep. 3, 2003.

### B. FIELD OF THE INVENTION

The present invention relates to optical data storage and, more particularly to storage media containing semi-reflective layers formed from silver alloys.

### C. BACKGROUND OF THE INVENTION

Reflective metal thin films are used in creating optical storage media. These thin metal layers are sputtered onto patterned transparent disks to reflect a laser light source. The reflected laser light is read as light and dark spots of certain length, converted into electrical signals, and transformed into images and sounds associated with music, movies, and data. All optical media formats, including compact disk (CD), laser disk (LD), and digital video disk (DVD) media, employ at least a single reflective metal layer, L1, for which aluminum has been the metal of choice. More advanced optical media utilize multiple reflective layers to increase the storage capacity of the media. For instance, many DVD's such as DVD 9, DVD 14, and DVD 18 contain two reflective layers, which enables two layers of information to be read from one side of the disk. The second layer, known as the L0 semi-reflective layer, must be thin enough, typically about 10 nm thick, to allow the underlying L1 layer to be read, but it must still be sufficiently reflective, about 18% to about 30% reflectivity, to be read. The disk can further include one or more additional semi-reflective layers read from the same side as the L1 and L0 layers.

When digital data is read from an optical storage medium, the lengths of the pits, typically of 9 different lengths, are read using internal clock timing and converted into a high frequency electrical signal, which is truncated to generate square waves and transformed into a binary electrical data stream.

Variances in the length of the pits caused by molding the polycarbonate or the incomplete metallization of the entire pit can cause errors in interpreting the data reflected by the laser. For optical media applications, the electronic circuits that interpret the data are specially designed to allow for a certain number of errors. There are four primary error indicators for optical media data. These critical parameters are categorized as:
1) PI—the total number of unreadable pits within a specified area; while industry standards allow for 280 defects, many companies hold this parameter to a maximum of 100
2) Jitter—the timing variation in pit or land length compared to the internal clock pulses; the industry maximum is 8%
3) Reflectivity—the percentage of laser light reflected from the pits; the industry standard is 18 to 30%
4) I-14—the variance in the longest pit length; the industry standard is less than 0.15% within one revolution and less than 0.33% within the disk.

The initial quality of the master used for making the polycarbonate disks, the polycarbonate, and the reflective materials are critical to the production of accurate data. Not only must the metallizing material be capable of uniform deposition and reflectivity, it must also be capable of fully filling the data storage pits that store the data. In addition, the industry uses an environmental test that subjects the disk to a specific temperature and humidity for a specified period of time. The industry standard for this test is temperature of 70° C. at 50% relative humidity for 96 hours (70/50/96). Many companies have adapted stricter internal specifications to raise the temperature to 80° C. and humidity to 85% for 96 hours (80/85/96).

After manufacturing, the data storage disks are scanned for errors, exposed to the environmental testing chamber, and subsequently re-analyzed for errors. Any failures at any testing stage, based on industry standards for error rates, or marked deterioration, even if not actually failing, after environmental testing will lead to rejections. The environmental testing demands a corrosion resistant material for the reflective metallizations. While a thickness of 20 nm of Al generally is adequate for the fully reflective layer as produced, a thickness of 40 nm may be required to provide adequate reflectivity after environmental exposure. Typically, about 5 nm to 10 nm of the original aluminum layer is transformed into transparent aluminum oxide during this environmental test. The semi-reflective layer is more critical since its apparent thickness and reflecting qualities cannot change by more than about 10% of its original relative value during environmental exposure.

In addition to the testing noted above, there is also a non-industry specification regarding UV or sunlight exposure. It has been found that disks made with silver alloys can discolor when subjected to sunlight. While the chemistry of the reaction is not fully understood, it is caused by a combination of the silver alloy used for the semi-reflective layer and the adhesive used to attach it to the fully reflective layer. A disk is deemed to have failed once its reflectance falls below 18% for either the semi-reflective layer or the fully reflective layer, the latter being viewed through the adhesive and the semi-reflective layer.

Aluminum, gold, silicon and silver alloys have been successfully used to create reflective layers for optical storage media. Because of its low cost, excellent reflectivity and sputtering characteristics on polymeric materials, aluminum is an especially preferred metal for a reflective coating that is used almost exclusively whenever there is only one reflective data layer and is also used to form the fully reflective L1 layer on a two-layer DVD. However, aluminum oxidizes readily, and its reflectivity can be compromised upon environmental, exposure. This oxidation prohibits the use of aluminum for all but the fully reflective layer, where it is deposited more heavily than the semi-reflective layer would allow.

Gold and silicon were the first materials to be used for the semi-reflective layer in DVD construction, but both materials have significant drawbacks. Gold provides excellent reflectivity of red laser light, excellent sputtering characteristics, and superior corrosion resistance but is very costly. Silicon is also reflective and free from corrosion but does not sputter as efficiently as the other metals. Furthermore, silicon is brittle, and cracks may form during thermal cycling and mechanical flexing, which prevents delicate data from being read.

Silver, like gold, has excellent sputtering characteristics and reflectivity, but its corrosion resistance is inadequate for it to be used in pure form as the semi-reflective layer. However, it is known that small amounts of other metals, including precious and non-precious metals can be added to the silver to improve its properties for use in optical media. Typically, it is recommended to add up to 5 atm. % of such other metals, and in some cases up to 10 atm. %. For example, copper can extend the shelf life of the alloy, whereas palladium improves both tarnish resistance and adhesion to plastics. Platinum improves corrosion resistance, manganese will temper its reflectivity, whereas titanium improves tarnish resistance and grain structure.

Japanese Unexamined Patent Publication JP05-012710 discloses an optical information recording medium containing a layer of a metal alloy stacked on an organic pigment layer, wherein the main component of the metal alloy is at least one of gold, copper, silver and aluminum, the alloy including at least one of tin, indium, germanium, silicon, lead, gallium, thallium, antimony, bismuth and zinc. The disclosed alloys are stated to be of reduced melting point and heat conductivity, and readily deformable by heat and/or gas generated by a recording laser beam. Japanese Unexamined Patent Publication JP02-192046 discloses a magneto-optical information recording medium having a silver based reflecting layer containing at least 2 atm. % manganese and optionally at least 1 atm. % tin.

For the manufacture of optical data recording and storage media, there is an ongoing need for alternate silver alloys with uniform sputtering characteristics and improved corrosion resistance that do not require the inclusion of more expensive precious metals. This need is met by the alloys of the present invention, whose properties make them especially suitable for use in optical data recording and storage media, in particular, for use in the semi-reflective layer of a DVD.

### D. SUMMARY OF THE INVENTION

An optical data recording and storage medium includes a thin semi-reflective layer and a highly reflective layer, wherein the semi-reflective layer is formed from a silver alloy consisting essentially of pure silver (as herein defined) and not more than about 1.0 wt. % tin, based on the total weight of alloy, or between about 0.1 to about 1.0 wt. % tin.

The silver alloy may, without adverse effect for the intended purpose, also include some copper but in an amount less than about 1.0 wt. % copper, based on the total weight of alloy.

### E. BRIEF DESCRIPTION OF THE DRAWINGS

FIG. 1 is a schematic representation of an optical data storage disk that depicts two reflective layers, one of which is a thin semi-reflective layer, and their positions in the disk.

FIG. 2 is a schematic representation of pits and lands corresponding to digital data recorded on an optical data storage disk, together with a reflective signal produced by this layer.

FIG. 3 is a graph showing the reflectivity of metallic silver, aluminum, and gold over the visible spectrum of light.

FIG. 4 is a schematic illustration of an electrical signal as it is read from an optical media storage disk.

FIG. 5 is an illustration of the data tracks in various optical media formats.

### F. DETAILED DESCRIPTION OF THE INVENTION

As pure silver has excellent reflectivity but insufficient corrosion resistance to be used as the semi-reflective layer in a multilayered optical data storage disk, silver is alloyed with other metals such as copper, gold, manganese, palladium, platinum, titanium, and zinc to improve its properties for current commercial use in optical media. While these additives, among others, used in various combinations to a silver alloy have been proven useful for optical media, I have discovered an even simpler silver alloy retaining substantially the full benefits of pure silver but substantially eliminating its inadequacies for this purpose. This is accomplished, for reasons as will be seen, by adding only a very small amount of tin, not exceeding about 1.0 wt. % based on total weight, to pure silver, where pure silver is defined as including not more than 500 parts per million of native trace elements. Addition to silver only of this very small amount of tin will, as I have discovered, sufficiently improve its corrosion resistance while maintaining essentially the high reflectivity benefits of pure silver, thereby providing a desirable material for use in thin-film semi-reflective layers of optical recording and storage media. Not only does the invention eliminate any need for additive precious metals, it also limits the total number of additives, thus making it commercially easier both to produce a uniform alloy composition and to simplify even further metal recovery from spent sputtering targets.

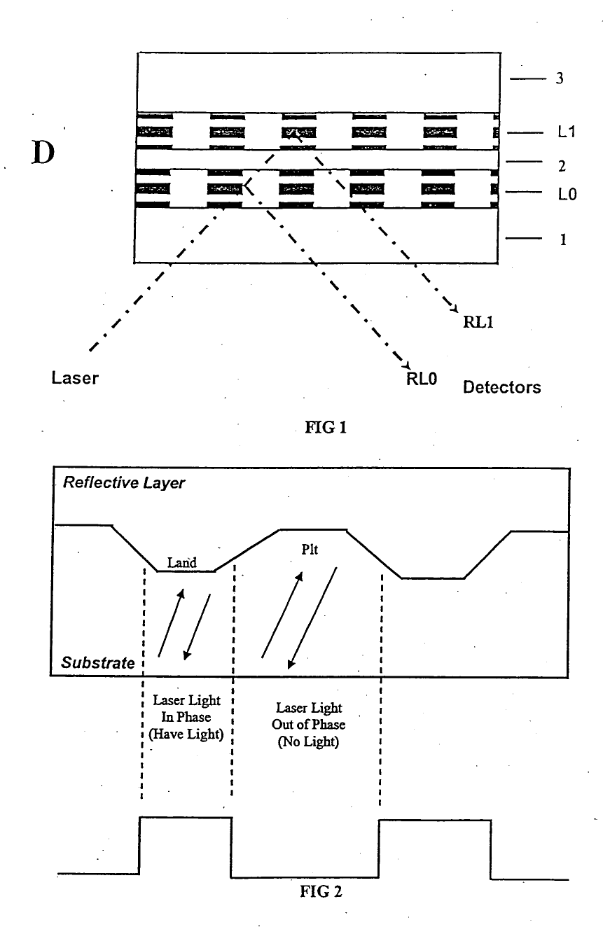

FIG. 1 schematically depicts an optical data storage disk D containing reflective layers L1 and L0. Reflective layer L1 is the fully reflective layer and is typically formed from aluminum. The thin semi-reflective layer L0 is formed from a silver-copper-tin alloy, as described above. Light from a laser source that is reflected from layer L1 is designated RL1 similarly, light reflected from layer L0 is designated RL0. The reflected light RL1 and RL0 is sensed by detectors. It should be noted that the light from a laser source must penetrate the semi-reflective layer L0 twice in order to read layer L1.

In disk D, layers 1 and 3, which typically are formed from a plastic such as polycarbonate or polymethylmethacrylate (PMMA), are imprinted with digital information comprising pits and lands. Layer 2 is an adhesive layer, typically comprising a DY-curable epoxy material, that is used to join layers 1 and 3.

FIG. 2 schematically illustrates the digital interpretation of the information stored on optical data disk D. The lands are at a distance from the laser and the detector such that reflected signals return to the detector in phase (bright), while the pits are at a second distance such that the signal returns to the detector out of phase (dark).

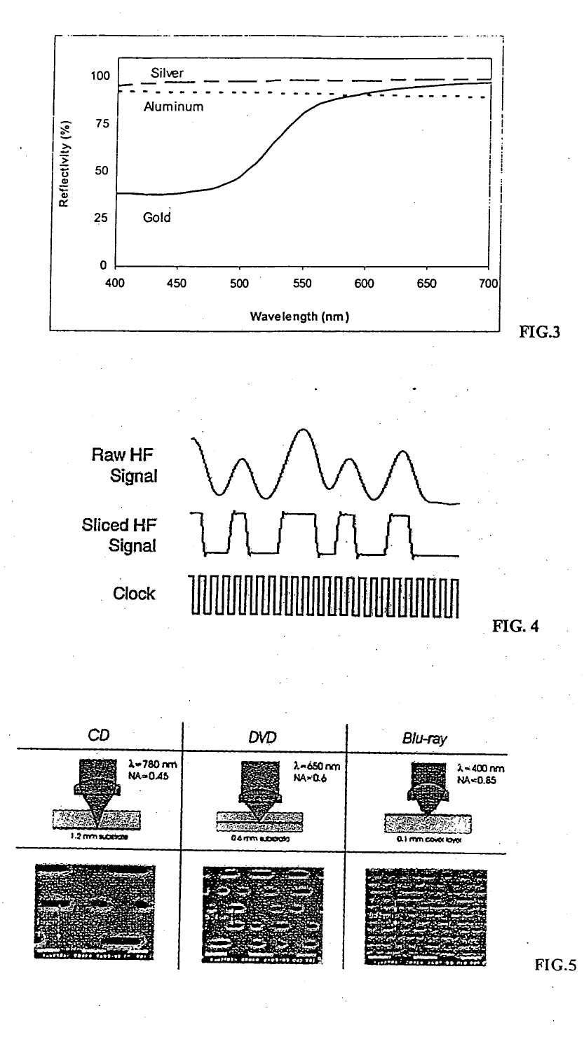

FIG. 3 shows the reflectivity of several important metals—silver, aluminum, and gold—over the visible spectrum of light. Most optical data disks are read with light waves approximately 650 nm, in the red portion of the visible spectrum. More recently, however, blue light-emitting laser diodes have become commercially available, which enables the storage and reading of much denser data. As shown in FIG. 3, metallic silver exhibits high reflectivity across the entire visible light spectrum.

FIG. 4 illustrates the sinusoidal electrical signal read from an optical media storage disk that depicts how it is truncated and compared to an internal clock to decipher the pulse length and data contained on the disk.

FIG. 5 is an illustration of the data tracks and pits used for data storage on CD, DVD and Blu-ray optical media formats. The new blue laser format, which employs a higher frequency (higher clock rate) laser to discern smaller data pits with less distance between tracks, allows for five times as much data as on a disk using a red laser, making it especially useful for high definition television (HDTV) formats. Optical data recording and storage disks having reflective layers formed from silver-copper-tin alloys can be used with blue lasers.

Corrosion resistant silver based alloys according to the invention are formed by the inclusion with pure silver of about 0.1 to no more than about 1.0 wt. % of tin, preferably about 0.25 to about 0.50 wt. % of tin, based on the total weight of alloy. Optionally, the silver-tin alloys can also include, for the purpose of further enhancing corrosion resistance, a very small amount of copper not exceeding about 1.0 wt. %, but preferably about 0.5 wt. % or less. Thin semi-reflective layers having a thickness preferably of about 5 nm to about 25 nm, more preferably, about 10 nm to about 20 nm, can be formed from these alloys by sputtering techniques well known in the art. When an alloy according to the invention is deposited as such a thin layer, I have found that, by limiting the amount of tin to less than 1.0 wt. %, the tin substantially entirely is deposited at the grain boundaries of the silver, thus causing a fine silver grain size while improving its corrosion resistance. Because the tin is substantially entirely deposited at the grain boundaries of the silver, it is not present in sufficient amounts within the silver grains to significantly affect the desired silver properties.

Test conditions for various comparison alloys and alloys according to the invention included 1) an initial test run shortly after preparation of the DVD; 2) 70/50/96—a test following exposure of the DVD to a chamber at 70° C., 50% relative humidity (RH) for 96 hours; and 3) 80/85/96—a test following chamber exposure at 80° C., 85% RH for 96 hours. As previously noted, PI is the industry standard terminology for defective pits within a certain area, jitter is caused by a combination of factors and is limited to 8%, and I-14 is a measure of the longest pit based on the length of the internal clock. The test data are presented in pass (P) and fail (F) notation for each of the conditions and criteria. Current requirements for DVD environmental testing are based on the less harsh test of 70/50/96. However, most of the major DVD replicators use the more severe 80/85/96 test for internal quality assurance.

### COMPARISON EXAMPLE 1

Pure silver failed in Jitter in test 2 and in all three PI, Jitter and I-14 in test 3.

### COMPARISON EXAMPLES 2 and 3

Silver with 0.7 wt. % copper (Example 2) and Silver with 0.7 wt. % copper and 0.7 wt. % silicon (Example 3) failed in I-14 in all three tests and in PI and Jitter in test 3.

### COMPARISON EXAMPLES 4 and 5

Silver with 0.7 wt. % copper and 0.25 wt. % aluminum (Example 4) and Silver with 0.5 wt. % copper and 0.75 wt. % manganese (Example 5) failed in I-14 in all three tests.

### COMPARISON EXAMPLE 6

Silver with 1.5 wt. % tin failed in I-14.

### INVENTION EXAMPLE 1

0.5 wt. % tin and the balance silver.

### INVENTION EXAMPLE 2

0.5 wt. % tin, 1.0 wt. % copper and the balance silver.

### INVENTION EXAMPLE 3

1.0 wt. % tin, 1.0 wt. % copper and the balance silver.

### INVENTION EXAMPLE 4

0.25 wt. % tin, 0.5 wt. % copper and the balance silver.

### INVENTION EXAMPLE 5

0.25 wt. % tin and the balance silver.

### INVENTION EXAMPLE 6

0.5 wt. % tin and the balance silver.

Tests have shown that produced Invention Examples 1, 2 and 3 all passed the desired test conditions, and based on those results, produced Invention Examples 4, 5 and 6 are also expected to pass. Contrary to the invention, the comparison examples all within the broad prior art standards of up to 5 atm. % additives to silver did not pass all commercial tests, including Comparison Example 6 with 1.5 wt. % tin.

DVDs that include silver/tin or silver/tin/copper in the desired proportions for the semi-reflective layer produced passing results in all three of the standard industry tests under 70/50/96 exposure conditions and, surprisingly, also under the more stringent 80/85/96 conditions. These results demonstrate that, for semi-reflective layers, the inclusion with pure silver essentially only of tin and optionally copper, each at levels of no more than about 1.0 wt. % of total weight, and preferably no more than 0.5 wt. % each of total weight, provides beneficial results even under severe environmental test conditions.

Particular reference to certain preferred embodiments is made by this invention, but it is understood that variations and modifications can be effected within the spirit and scope of the invention.

1. An optical data recording and storage medium comprising a thin semi-reflective layer and a highly reflective layer, wherein the semi-reflective layer has a thickness of about 5 nm to about 25 nm and is formed essentially from a silver alloy consisting essentially of pure silver and about 0.1 to about 1.0 wt. % of tin, based on the total weight of the alloy, with the tin deposited substantially entirely at the grain boundaries of the silver in the semi-reflective layer.

2. The optical data recording and storage medium of claim 1 wherein the silver alloy consists essentially of silver and about 0.25 wt. % to about 0.5 wt. % of tin, based on the total weight of alloy.

3. The optical data recording and storage medium of claim 1 wherein said thin semi-reflective layer has a thickness of about 10 nm to about 20 nm.

4. An optical data recording and storage medium comprising a thin semi-reflective layer and a highly reflective layer, wherein the semi-reflective layer has a thickness of about 5 nm to about 25 nm and is formed essentially from a silver alloy consisting essentially of pure silver, about 0.1 to about 1.0 wt. % of tin, and about 0.1 to about 1.0 wt. % of copper, based on the total weight of the alloy, with the tin deposited substantially entirely at the grain boundaries of the silver in the semi-reflective layer.

5. The optical data recording and storage medium of claim 4 wherein the silver alloy consists essentially of silver, about 0.25 wt. % to about 0.5 wt. % of tin and less than about 0.5 wt. %, based on the total weight of alloy.

6. The optical data recording and storage medium of claim 5 wherein said thin semi-reflective layer has a thickness of about 10 nm to about 20 nm.
